(19) United States
(12) Patent Application Publication
(10) Pub. No.: US 2003/0014748 A1
(43) Pub. Date: Jan. 16, 2003

(54) Methods for data transmission

(76) Inventors: Gal Ben-David, Mitzpe Adi (IL); Reuben Halevi, Haifa (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/939,580

(22) Filed: Aug. 28, 2001

Related U.S. Application Data
(60) Provisional application No. 60/305,074, filed on Jul. 16, 2001.

(51) Int. Cl. H04N 7/16

(52) U.S. Cl. 725/23

(57) ABSTRACT

A method for data modulation comprising transmitting lines of data on a screen the lines comprising at least one of at least two different colors, and modulating the data as a function of a period of time between consecutive transitions between two different colors.

### FIELD OF THE INVENTION

The present invention relates generally to methods and apparatus for transmitting digital data over graphic displays, and particularly to interval modulation of such data transmission

### BACKGROUND OF THE INVENTION

Information transfer from cathode ray tube (CRT) based devices is well known in the art. In general, a CRT is an electron gun that projects a beam (or three beams, for color) of electrons against a luminescent screen at the opposite end of the tube, where a bright spot of light appears where the electrons strike the screen. Depending on the phosphor type, different colored light is generated at the screen position hit by the electron beam. However, the light then fades quickly in 10 to 60 microseconds. This time depends on the persistence of the phosphor coating inside the screen. In general, the picture may be redrawn, i.e., refreshed, every 15 milliseconds. The refresh is done in order to make the human eye think that there is a steady picture/movie.

To produce a picture on the screen, the electron guns start a beam directed at the top of the screen and scan very rapidly from left to right. They then return to the left-most position one line down and scan again, and repeat this to cover the entire screen. In performing this scanning or sweeping type motion, the electron guns are controlled by the video data stream coming into the monitor from the video card, in the case of a computer, or the video signal, in the case of a television, which varies the intensity of the electron beam at each position on the screen. This control of the intensity of the electron beam at each dot is what controls the color and brightness of each pixel on the screen. Some implementations of CRT devices use screen interlacing, wherein the electron beam scans the odd lies and even lines interchangeably.

The television tube is a form of cathode-ray tube in which the beam scans the screen 525/625 times to form a frame, with 30/25 interlace frames (60/50 fields) being produced every second. These values apply to the NTSC and PAL standards (National Television Standards Committee and Phase Alternation Line), respectively. Each frame creates a picture by variations in the intensity of the beam as it forms each line. Computer monitors, on the other hand, often use higher number of lines (768 for XGA), higher refresh rates (up to 100 Hz) and in most cases do not use interlacing.

The prior art includes various patents that describe methods for data transmission from CRT devices. For example, U.S. Pat. Nos. 3,993,861 to Baer and 4,729,563 to Yokoi describe methods wherein transmissions are embedded into the video signal by means of screen cells. The cells are painted by digital hardware to short periods of black and white.

In U.S. Pat. No. 5,488,571 to Jacobs et al., assigned to Timex Corporation, the CRT video display has a video signal generator providing raster scanning of the screen and a program for formatting the binary coded data into blocks of serial data. The serial data is transformed into black and white lines that are shown on top of the CRT. U.S. Pat. No. 5,652,602 to Fishman et al., assigned to Microsoft Corporation, describes a coding method of sending white sequences of different length over a black background.

U.S. Pat. No. 4,807,031 to Broughton et al. describes a low-disturbance method. The basic method represents data by raising and lowering the luminance of successive horizontal lines within some designated viewing area. Because the average luminance of the two adjacent lines remains the same, the effect is not perceptible to the eye, but sensing of the alternate raising and lowering of the luminance by an appropriate receiver allows the data to be detected. Instead of a presentation of black and white lines, the method uses small deviations of line amplitude from the original video signal. The technique is equivalent to superimposing on the video signal a subcarrier frequency of 7.867 KHz (for an NTSC broadcast), which can be detected by appropriate filtering.

U.S. Pat. No. 6,094,228 to Ciardullo et al. describes a spread spectrum low-disturbance method. Data is transmitted in the form of groups of data bits called symbols. Each symbol has associated with it one of a predetermined number of longer sequences of “chips” called pseudorandom noise (PN) sequences. The PN sequence transmitted for any symbol is divided into a multiplicity of lines of chips. Each line of chips is transmitted together with its inverse, in pair-wise fashion, by embedding them in respective pairs of line scans of the video signal.

The abovementioned patents implement a communication system that is generally described in FIG. 1.

The entire transmitting portion of the system is referred to as a transmitter 10. Data is emitted by an information source 11 and sent to an information destination 24. An encoder 12 translates the data into a stream of two-dimensional image information that is shown as scan lines 15 on a CRT screen 14. The operation of the CRT requires an electronic beam scan circuitry 13 that converts the image into a one-dimensional intensity signal.

The entire transmitting portion of the system is referred to as a receiver 20, which may be a portable device, such as a toy, consumer loyalty device, wristwatch or a personal digital assistant (PDA). A photo sensor 21 is placed within the line-of-sight of CRT screen 14 and collects the emissions of light from the phosphor layer. In general, the signal at the output of the photo diode is a one-dimensional electronic signal that is band-limited by the fading nature of the phosphor layer. Noise from ambient light sources and electronic circuits is also present at the received signal at the output of the photo sensor 21. An amplifier 22 amplifies and decodes this signal by various methods known in the art.

### SUMMARY OF THE INVENTION

The present invention seeks to provide a method and system for transmitting data over scan graphic displays, and downloading the data to a receiver. In the present invention, a method is provided for transmitting information in various speeds and utilizations of a CRT screen. In one embodiment, a high rate of bits per seconds may be transmitted when the entire screen is used. In other embodiments, such as electronic coupons transmission, bit rates of only a few tens of bits per seconds may be required. The method permits data transmission using only a part of the screen, part of the time (transmission bursts). Transmission bursts may be used in parallel with normal TV broadcasts for the delivery of electronic coupons or the transfer of other small amounts of information, such as but not limited to, channel identification, programming information and interactive toy activation. Low cost receiver hardware may be used to carry out the invention, such as but not limited to, a low cost 8-bit microprocessor.

There is thus provided in accordance with a preferred embodiment of the present invention a method for data modulation including transmitting lines of data on a screen, the lines including at least one of at least two different colors, and modulating the data as a function of a period of time between consecutive transitions between two different colors.

In accordance with a preferred embodiment of the present invention the data is modulated as a function of a period of time between consecutive transitions between two different colors on different lines.

Further in accordance with a preferred embodiment of the present invention the data is modulated as a function of a period of time between consecutive transitions between two different colors on the same line. The modulating may include encoding one or more bits per line of data.

Still further in accordance with a preferred embodiment of the present invention the encoding includes providing a first segment of a first color on one side of the line and providing a second segment of the first color separated from the first segment by a second color.

In accordance with a preferred embodiment of the present invention the encoding includes modulating the data in relation to at least one of horizontal and vertical blanking of the lines of data.

Further in accordance with a preferred embodiment of the present invention the encoding includes transmitting no information during vertical blanking, and transmitting a preamble on a beginning of data in a new field.

Still further in accordance with a preferred embodiment of the present invention the encoding includes, during horizontal blanking, representing a one bit with a first time interval between two segments of color and representing a zero bit with a second time interval between two segments of color.

In accordance with a preferred embodiment of the present invention the modulating includes forming a preamble adapted to differentiate the data transmitted on the screen from another portion of the screen.

Further in accordance with a preferred embodiment of the present invention the modulating includes forming the preamble with lines of at least two different colors.

Still further in accordance with a preferred embodiment of the present invention the modulating includes forming the preamble with white and black lines, wherein an average value of the preamble is at least close to halfway between black and white gray levels.

In accordance with a preferred embodiment of the present invention the modulating includes forming the preamble with white and black lines, wherein the preamble includes a distance of a predefined number of lines between a predefined number of transitions between black and white.

Further in accordance with a preferred embodiment of the present invention the modulating includes representing a zero bit with a series of black-white segments, or additionally or alternatively, a one bit with a series of black-black-white segments or a white-black-white segments.

In accordance with a preferred embodiment of the present invention the modulating includes video-editing full frames of the data including both odd and even lines of the data. At least one of the odd and even lines of the data may be video-edited.

Further in accordance with a preferred embodiment of the present invention the method includes presenting the data in fields including at least one of odd-lines fields and even-lines fields. The odd-lines fields and even-lines fields of the data may be separated.

In accordance with a preferred embodiment of the present invention the data that has been modulated is decoded.

Further in accordance with a preferred embodiment of the present invention the modulating includes forming a preamble adapted to differentiate the data transmitted on the screen from another portion of the screen, and wherein the decoding includes clearing two variables, waiting for an input of an interval, and if the interval is shorter than a predefined period, keeping the two variables cleared, and if the interval is longer than the predefined period, then the data includes the preamble.

In accordance with a preferred embodiment of the present invention the decoding further includes waiting for an input of a new interval, and comparing the new interval with predefined limits to define a legal interval.

Further in accordance with a preferred embodiment of the present invention the legal interval includes a legal “zero” interval having a first predefined duration and a legal “one” interval having a second predefined duration.

Still further in accordance with a preferred embodiment of the present invention the modulating further includes adding at least one of error detection bits and error correction bits to the preamble.

In accordance with a preferred embodiment of the present invention the modulating further includes adding a toggle bit to the preamble, wherein the toggle bit is adapted to be toggled between one and zero.

Further in accordance with a preferred embodiment of the present invention the modulating includes integrating a coupon into a television (TV) advertisement campaign, the coupon being viewable on-screen during a TV commercial.

Still further in accordance with a preferred embodiment of the present invention an information key is transmitted that provides access to a hidden feature of a receiver used to receive the data.

There is also provided in accordance wit a preferred embodiment of the present invention method for data modulation including integrating a coupon into a TV advertisement campaign, the coupon being viewable on a TV screen during a TV commercial and receivable from the screen by a viewer.

In accordance with a preferred embodiment of the present invention the method includes inserting in the coupon a “get ready” prompt adapted to let a viewer know that the coupon is about to be shown on the screen.

Further in accordance with a preferred embodiment of the present invention the coupon is downloaded to a download device.

Still further in accordance with a preferred embodiment of the present invention the coupon is downloaded to a smart card.

In accordance with a preferred embodiment of the present invention the method further includes transferring data from the download device to at least one of a Point-Of-Sale (POS) device and a data kiosk.

Further in accordance with a preferred embodiment of the present invention the method includes issuing interactive commands with the coupon.

There is also provided in accordance with a preferred embodiment of the present invention a method for data modulation including transmitting data on non-interactive television, and modulating at least a portion of the data to permit a viewer to interact with data.

In accordance with a preferred embodiment of the present invention data is transmitted that is associated with a TV commercial.

Further in accordance with a preferred embodiment of the present invention the transmitting includes transmitting an information key that provides access to a hidden feature of a receiver used to receive the data.

### BRIEF DESCRIPTION OF THE DRAWINGS

The present invention will be understood and appreciated more fully from the following detailed description taken in conjunction with the appended drawings in which:

FIG. 1 is a block-diagram illustration of a prior art method for downloading information from a scan screen,

FIG. 2 is a simplified graphical illustration of a simplified response of a photo sensor to a single pixel;

FIG. 3A is a simplified graphical illustration of timing of an NTSC active portion of a scan line (52.4 μs) and horizontal sync blanking (11.1 μs);

FIG. 3B is a simplified graphical illustration of the screen intensity timing as a one-dimensional signal, showing tie active portion of each scan line and blanking, and wherein a vertical blanking of 1.3 ms occurs between the last line and the first line of a new field;

FIG. 4 is a simplified pictorial illustration of a screen modulation, in accordance with an embodiment of the invention, wherein whole lines are encoded;

FIG. 5 is a graphical illustration of a full screen transmission of screen lines for transmitting data from a screen, in accordance with an embodiment of the invention;

FIG. 6 is a graphical illustration of a partial screen transmission of screen lines for transmitting data from a screen, such as a burst of data embedded in a video clip, in accordance with an embodiment of the invention;

FIGS. 7A and 7B are simplified illustrations of another embodiment of the present invention, wherein portions of lines are used for encoding, wherein FIG. 7A illustrates a one-bit per line encoding and FIG. 7B illustrates more than one bit per line encoding;

FIG. 8 illustrates an example of the encoding of either FIG. 7A or 7B in a television broadcast;

FIG. 9 is a simplified block diagram illustration of a front-end of the receiver, in accordance with a preferred embodiment of the present invention;

FIG. 10 is a simplified block diagram of circuitry useful with the receiver of the present invention;

FIG. 11 is a simplified graphical illustration of a response to normal video content at the output of the filter stage, in accordance with a preferred embodiment of the present invention;

FIG. 12 is a simplified graphical illustration of a typical output of a filtered signal received by the embodiment of FIG. 4, in accordance with an embodiment of the invention;

FIG. 13 is a simplified illustration of a response to video that is modulated at the output of the filter stage of the embodiment of FIG. 7A, in accordance with an embodiment of the present invention;

FIGS. 14 and 15 are simplified flowcharts of decoding intervals in accordance with preferred embodiments of the present invention, corresponding respectively to the embodiments of FIGS. 7A and 7B.

FIGS. 16A and 16B are simplified illustrations of two portable devices for coupon redemption, constructed and operative in accordance with two preferred embodiments of the present invention;

FIG. 17 is a simplified illustration of a “get ready” prompt to alert a viewer of a coupon to be shown on a screen, in accordance with an embodiment of the invention; and

FIGS. 18A and 18B are simplified illustrations of a method for interactive advertising using non-interactive television, in accordance with an embodiment of the present invention.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but is not limited to, any type of disk including floppy disks, optical disks, magnetic-optical disks, read-only memories (ROMs), compact disc read-only memories (CD-ROMs), random access memories (RAMs), electrically programmable read-oily memories (EPROMs), electrically erasable and programmable read only memories (BEPROMs), magnetic or optical cards, or any other type of media suitable for storing electronic instructions, and capable of being coupled to a computer system bus.

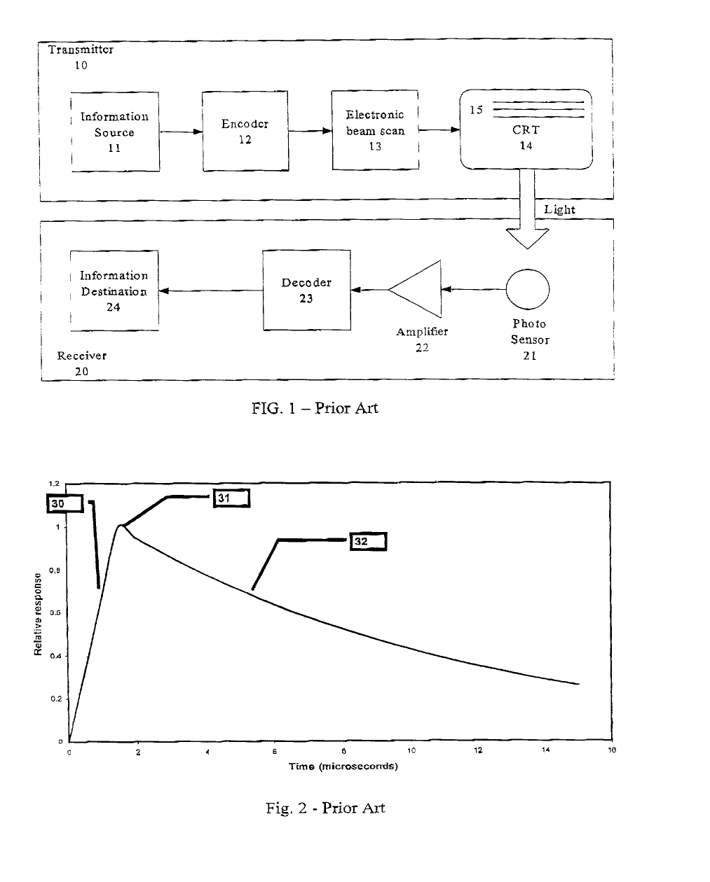

The present invention may use a portable device for receiving data in a manner similar to that described with reference to the receiver 20 of FIG. 1. To transfer data to the portable device, the device is held near and facing the screen. The transmitter may be programmed to display a sequence of display frames in which selected pixel-sequences are illuminated to represent data. Pixels may be illuminated in different colors and intensities based on the coding scheme that is disclosed further.

The scan process of the CRT progressively illuminates all screen pixels. The electrical response of the receiver photo-sensor is a convolution sum of responses to individual pixels. A simplified response of the photo sensor to a single pixel is shown in FIG. 2.

The phosphor builds up brightness in a brightness pulse 31 during an excitation period 30. Afterwards, the brightness decays during a period of time 32 determined by the persistence of the phosphor. The relative amplitude of the brightness pulse 31 is a function of the electronic command given by either luminance (gray level) or chrominance information. In a preferred embodiment only luminance encoding is used. It will be appreciated by skilled artisans that usage of chrominance encoding is analogous. The use of more than one color for data transmission, in conjunction wit color filters in the receiver may also be implemented.

In some embodiments of the present invention a computer program may present a series of synthetic images that comprise information bits. Those skilled in the art will appreciate that the presentation of these images may be done in a fast way that is preferably synchronous with the screen refresh process. In a preferred embodiment, MICROSOFT DIRECTDRAW technology may be used for that purpose. For the desired method, two memory image-buffers may be maintained. The two buffers may be used in a double buffering technique; one is shown on the screen while the other is updated in the background. Background update includes drawing of line segments in a way that is explained further hereinbelow. When background updating is done, the two buffers are flipped, i.e., the background buffer turns into the foreground buffer and vice versa. The buffer flip may be synchronized with the screen refresh by the computer video display card.

In some cases the update of the background buffer may be too slow to be ready to for the next screen refresh. In this case, two or more consecutive screen refreshes occur with the same data. In such a case, a receiver may be used to receive the new incoming data which includes the two or more consecutive screen refreshes.

In another embodiment, the information is attached to a video signal. This may be done either off-line during editing of the television show or commercial, or during a TV broadcast by picture-in-picture modulators.

In one embodiment of the present invention, some or all screen lines, such as the screen lines 15 shown in FIG. 1, may be used for data modulation by setting their intensity. The information may be modulated by the period of time between consecutive black-to-white (or white-to-black) transitions. It is noted that although the present invention is described with the use of black and white gray levels, those skilled in the art will appreciate that other gray levels may be used, and different transitions from one color to a different color may be used.

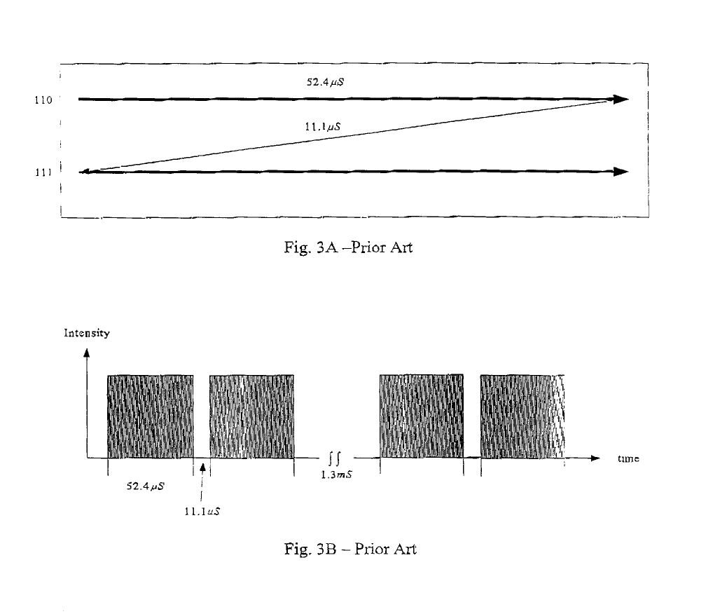

Reference is now made to FIG. 3A, which illustrates an example of NTSC video signal timing. The active portion of a scan line, whose intensity is controllable, has a duration of about 52 microseconds. Between two consecutive lines (110 and 111), there is a blanking period with a duration of about 11 microseconds, which is not controllable. i.e., it is always black. Between the last line and the first line of the next field, there is a 1.3 millisecond vertical blanking period (which is again black, i.e., no control).

FIG. 3B illustrates the screen intensity timing of tie NTSC video signal, shown in FIG. 3A, as a one-dimensional signal, showing the active portion of each scan line and blanking, and wherein vertical blanking of 1.3 ms occurs between the last line and the first line of a new field, as mentioned in the previous paragraph. The time intervals whose intensity is controllable are shown as rectangles.

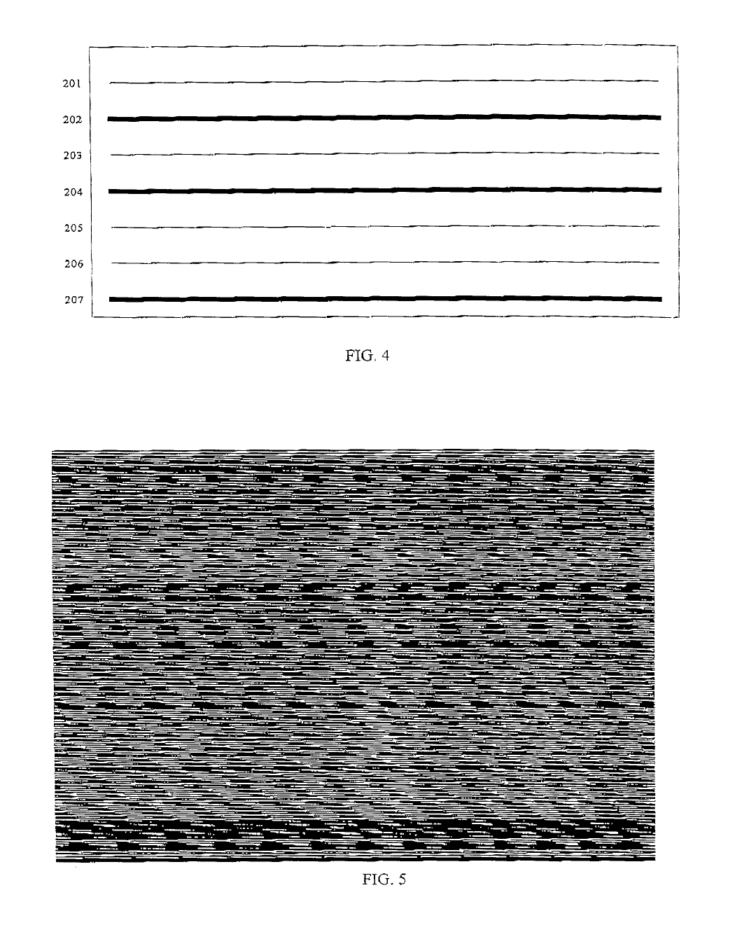

Reference is now made to FIG. 4, which illustrates a screen modulation, in accordance with an embodiment of the invention, wherein whole lines are encoded.

Entire lines may be encoded to be either black (represented by a thin line) or white (represented by a thick line). The encoding may be done by the time between two black-to-white or white-to-black transitions. In a preferred embodiment, the distance between two consecutive white lines is used. A distance of one black line (203) between two white lines (202 and 204) represents a “zero” data bit. A distance of two black lines (205 and 206) between two white lines (204 and 207) represents a “one” data bit.

The modulation may start with the preamble whose role is to differentiate the data transmission from the rest of the screen that may display other video information. For example, in the embodiment illustrated in FIG. 4, a distance of more than two lines may represent a transmission preamble. In one embodiment, the preamble may comprise two white lines followed by two black lines followed by two black lines and one white line, for example. In this embodiment, the preamble is recognized by a distance of four lines between two black-to-white transitions. Moreover, the preamble has an average value that is close to halfway between black and white gray levels, which may be useful to reject low frequency components. In addition to the data bits, error detection bits and error correction bits may be added. It should be appreciated that other transition periods may be used.

As mentioned hereinabove, the update of the background buffer may be too slow to allow new data to be transmitted in every screen refresh. In such cases, the receiver may see the same data more than once. In order to overcome his problem, a toggle bit may be added to the transmitted data. This bit may be toggled between one and zero and may be shown in parallel with the payload data. The receiver preferably maintains the status of this bit and recognizes that new data is presented when it is changed.

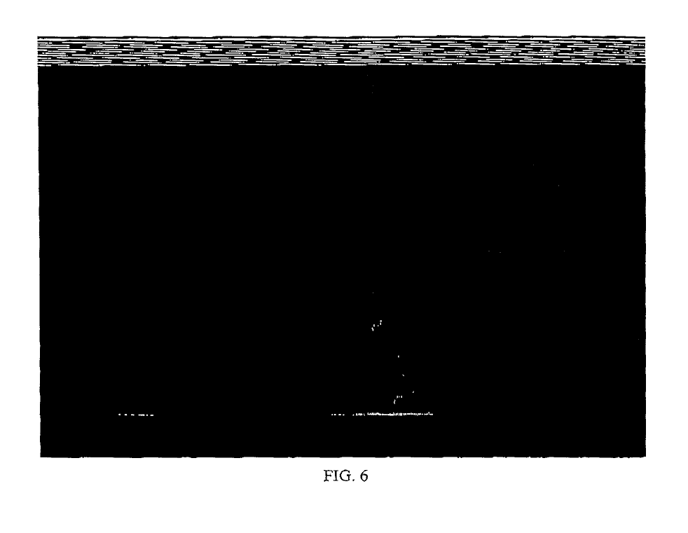

A general view of a full screen transmission is shown in FIG. 5, while a burst of data embedded in a video clip is shown in FIG. 6.

In one preferred embodiment, the transmitter uses a computer CRT screen with 800 columns by 600 lines resolution and a refresh rate of 72 Hz, a total of 43,200 scan lines per second. It is appreciated that different resolutions and refresh rates are also within the scope of the invention. Since in the average, about 2.5 lines are used for each data bit, a data rate of about 17,000 bits per second may be obtained. A real data rate of about 15,000 bits per seconds may be achieved when various screen lines are used for preambles and error control codes.

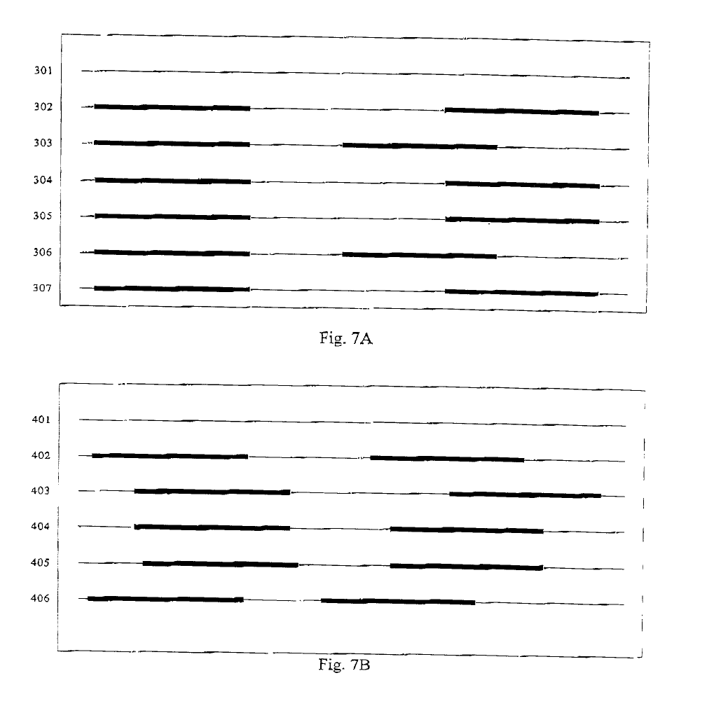

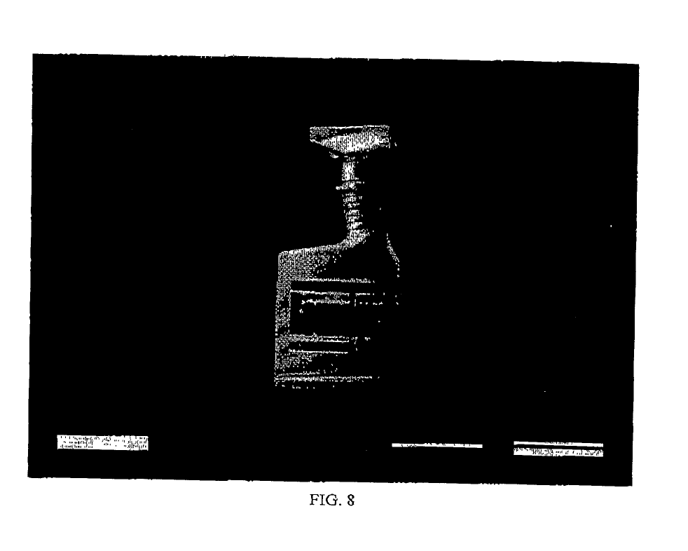

Reference is now made to FIGS. 7A and 7B, which illustrate another embodiment of the present invention, wherein portions of lines are used for encoding.

FIG. 7A illustrates a one-bit per line encoding. Thin lines represent low screen intensity (black), while thick lines represent high screen intensity (white). In one preferred embodiment, a data modulated line may contain a fixed white segment on one side, e.g., its left side, as seen in lines 302-307. Another white segment may be used to represent a single bit (either 0 or 1) by its distance from the fixed white segment. In the illustrated embodiment, a short distance represents a binary 1, as in lines 303 and 306, whereas a long distance represents a binary 0, as in lines 302, 304, 305 and 307. Those skilled in the art will appreciate that in the embodiments of FIGS. 7A and 7B, channels may be data modulated to convey information in a variety of ways, including but not limited to, Pulse Modulation (PM), Pulse Place Modulation (PPM), Pulse Width Modulation (PWM) Amplitude Modulation (AM), Return to Zero (RZ), and/or Non-Return to Zero (NRZ), or any other temporal modulation and coding technique.

FIG. 7B illustrates more than one bit per line encoding, which may take into consideration the horizontal and vertical blanking explained above with reference to FIGS. 3A and 3B. In a preferred embodiment, during vertical blanking, no information is transmitted. A preamble is transmitted on the beginning information transmission in each field. During horizontal blanking two alternative timings may be used for 0 and 1 bits. For example, 20 μs (relative portion of 20/52.4 of active line) and 40 μs may represent binary zero, while 30 μs and 50 μs may represent binary one. When encoding a bit by drawing a white line on the screen at a corresponding distance from a previous line, the shorter option (that is, in this example, 20 μs for zero and 30 μs for one) may be checked first. If the timing requirement requires a part of a white line to be placed at the horizontal blanking period, then the longer period option may be used (that is, in this example, 40 μs for zero and 50 μs for one).

FIG. 8 illustrates an example of the encoding of either FIG. 7A or 7B in a television broadcast.

It is noted that television broadcasters, cable and satellite stations may use digital compression techniques as a part of be TV broadcasting channel. Three widely used compression techniques are ISO/IEC 10918 (M-JPEG), ISO/IEC 11172 (MPEG-1) and ISO/TEC 13818 (MPEG-2). These compression schemes use a DCT—Discrete Cosine Transform and are not optimized to compress synthetic “narrow” line segments, and thus may be distorted. In such cases, it may be necessary to duplicate data lines in order to form wider lines that are less sensitive to DCT-based compression.

In a preferred embodiment, the video signal is sampled by a video capture PC card, such as the DC30Plus, available from Pinnacle Systems Inc., 280 N. Bernardo Ave., Mountain View Calif. 94043. The card employs the M-JPEG compression scheme.

The modulation may be implemented using an off-the-shelf video-editing tool, such as Adobe Premiere, available from Adobe Systems Incorporated, 345 Park Avenue San Jose, Calif. 95110-2704. The combined video and modulation signal may be converted to analog video using the DC30Plus card.

Those skilled in the art will appreciate that the modulation may be added by the video-editing tool into full frames (both odd and even lines), but may be presented by the video in fields (odd-lines field and even-lines field). The modulation may therefore be calculated to separate odd-lines and even-lines fields, and then combined into full frames by the video-editing tool.

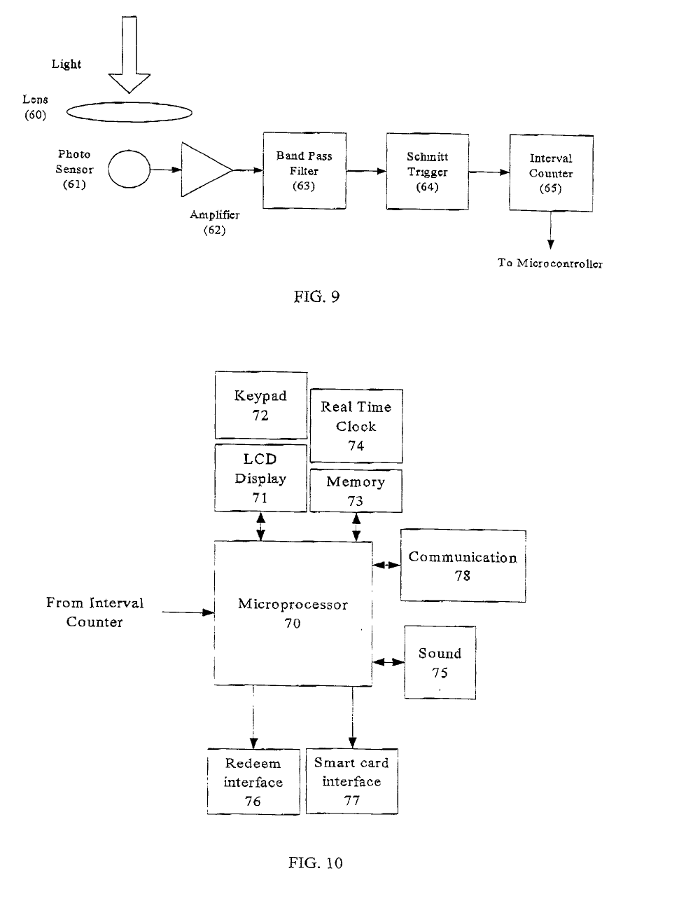

Reference is now made to FIG. 9, which illustrates a block diagram of a front-end of the receiver, in accordance with a preferred embodiment of the present invention.

An optical sensor 61 may receive optical information from a TV/computer screen. A focus lens 60 may be used to impose a narrow viewing angle, thus enabling remote transmission from the monitor screen to the receiver (e.g., around 3 meters). The optical signal may be amplified by an amplifier 62 and filtered by a filter 63, such as a band pass filter.

In one embodiment, a photodiode with a build-in lens and amplifier may be used, such as IPL10530AAL, commercially available from INTEGRATED PHOTOMATRIX INC., 4282 Reynolds Drive Hilliard, Ohio 43026. Band pass filter 63, typically but not necessarily, between 10 KHz and 500 KHz, may filter out ambient light (50/60 Hz-100/120 Hz) and screen vertical refresh rate (50-100 Hz), as well as high frequency noise.

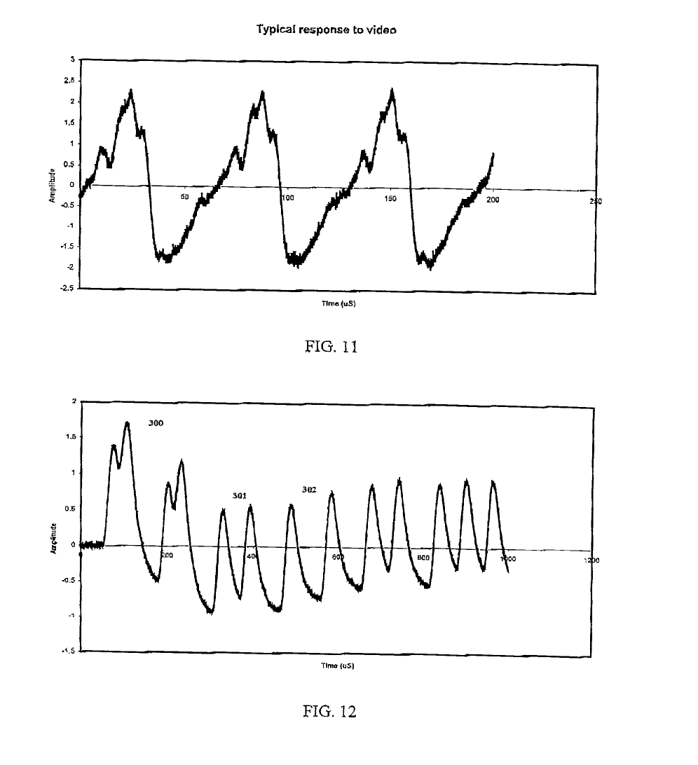

Reference is now made to FIG. 11, which illustrates a response to normal video content at the output of the filter stage, in accordance with a preferred embodiment of the present invention.

A horizontal refresh period of around 63 microseconds (for NTSC) may be clearly seen in FIG. 11. Normal video content is therefore characterized by 63 μs intervals between two consecutive negative-to-positive zero crossings.

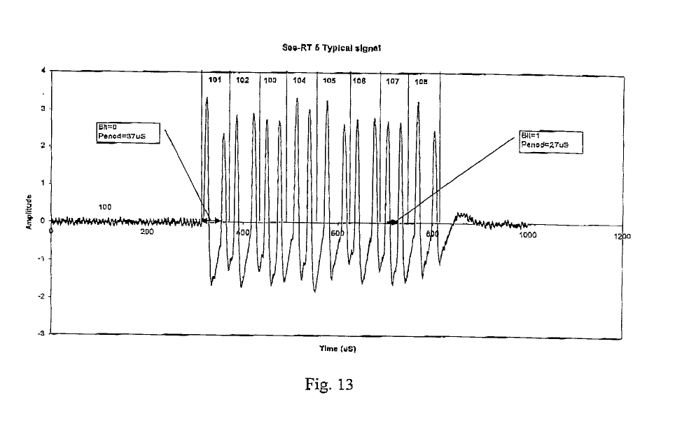

Reference is now made to FIG. 12, which illustrates a typical output of the filtered signal in accordance with the embodiment described hereinabove with reference to FIG. 4. Positive pulses are caused by white lines. Two consecutive white lines cause a “camel-like” dual peak as seen twice at reference numeral 300. The average of the preamble sequence causes white peaks to be of a positive voltage and black sequences to be of a negative voltage. A “zero” bit is decoded when a short period occurred between two black-to-white transitions (301). A longer period is interpreted as the bit “one”.

Reference is now made to FIG. 13, which illustrates a response to video that is modulated at tile output of the filter stage of the embodiment of FIG. 7A, in accordance with an embodiment of the present invention.

As mentioned earlier, a black preamble 100 may be used to recognize the beginning of the data modulation. The response to a white line segment may be a short positive pulse. In a preferred embodiment, a bit may be represented by a single line containing two white line segments, as shown hereinabove in FIG. 7A. In a preferred embodiment, a total of preamble and eight data bits (two positive pulses per bit) may be sent in each field (60 fields per second for NTSC).

FIG. 13 illustrates the response to eight lines (101 to 108) that are modulated by the two-segment method, as described hereinabove. In an embodiment of one-bit per line encoding, the left pulses in data lines are fixed and are placed on top of each other. These lines are the first to be illuminated in each line. Therefore, the distance between corresponding pulses is fixed in the preferred embodiment and equals the horizontal refresh period (63 μs). The time difference between the first pulse and second pulse in each line represents the information bit; zero is represented by a 37 μs interval, while a 27 μs interval represents binary 1.

Referring again to FIG. 9, it is seen that the output of the band pass filter 63 may be entered via a Schmitt trigger 64 comparator into an interval counter 65 that emits the time between adjacent negative-to-positive zero crossing events.

Reference is now made to FIG. 10, which illustrates circuitry useful with the receiver of the present invention.

The output from the interval counter 65 may be input to a microprocessor 70. For example, the interval counter 65 may comprise without limitation a 0.8 μs resolution self-reset counter that is comprised in the microprocessor 70 in a CAPTURE/COMPARE/PWM (CCP) internal peripheral. A new interval may be entered once every few tens of microseconds. The use of a hardware interval counter (either stand alone or CPU peripheral) that emits interval data at a relatively slow rate enables the use of a low cost microprocessor, such as an 8-bit microprocessor, 16C773 by Microchip Technology Inc., (2355 West Chandler Blvd., Chandler, Ariz. 85224-6199). As mentioned before, the period of time between consecutive transitions may be measured by an internal CCP Module.

The main section of the receiver may include further functionality. The information that was received from the screen as well as other data may be stored in a memory 73. The memory may also store personal user information, such as a loyalty program ID. Alternatively the loyalty program ID may be placed on a sticker with or without a barcode. The memory may also store information and capabilities that are stored in the device during manufacturing. These capabilities may be “hidden” until enabled by a transmission of a key.

A real time clock 74 may be used to check the expiry dates of coupons and to enable further statistical analysis on promotional effectiveness as compared with known TV show timing.

Sound 75 may be used to inform the user of the receiver status, such a but not limited to, Idle, Wait for screen information, Screen information reception in progress, Data received OK, Data received with errors. Silence (Idle state) and four different sound effects (beeps) may be preprogrammed for this example. For toy applications the sound may add further attractiveness to children.

A small keypad 72 and an LCD display 71 may be used to interact with the user Coupons may be presented on the LCD screen and the keys may be used to scroll among valid coupons, to toad new coupons from the screen and to erase those that are no longer wanted.

Redemption of the coupons may be done at lie retailer, without limitation, by any combination of one or more of the following methods:

a. A coupon bar code may be presented on the LCD screen and read by the point of sale (POS) barcode reader. The receiver marks the coupon as used when its barcode is shown.

b. The receiver loads the coupons into smart cards (using, for example, but not limited to, the ISO-7816 standard) with coupons and these are used at the POS in a normal manner.

c. Optical transmitter (e.g., Infra-Red) to a proprietary POS peripheral device.

d. RF transmitter (e g., BLUETOOTH, cell phone SMS) to a proprietary POS peripheral device.

e. Direct physical connector.

In an alternative embodiment we coupon may be redeemed at a data-kiosk instead of directly at the POS. The data-kiosk may be corrected to a POS network or may simply print a paper coupon.

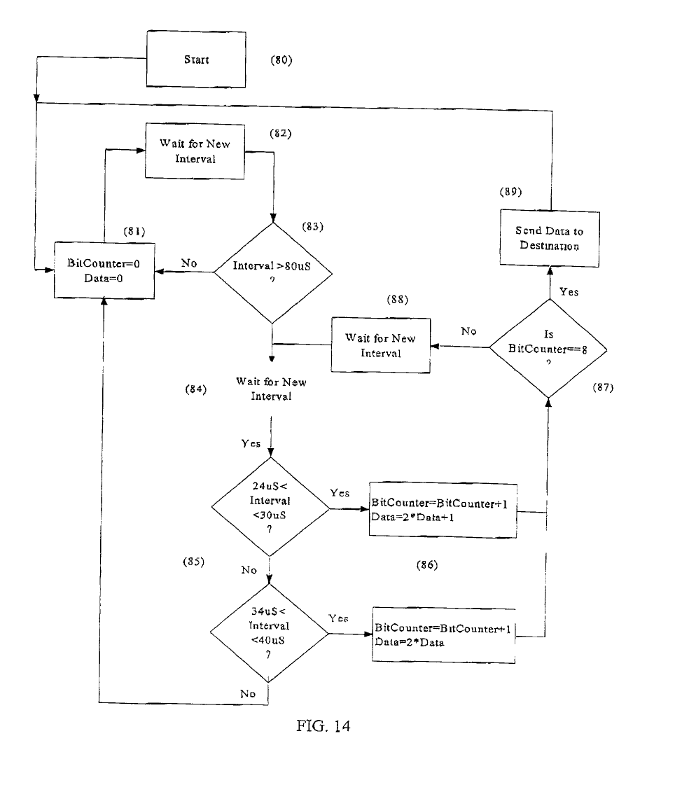

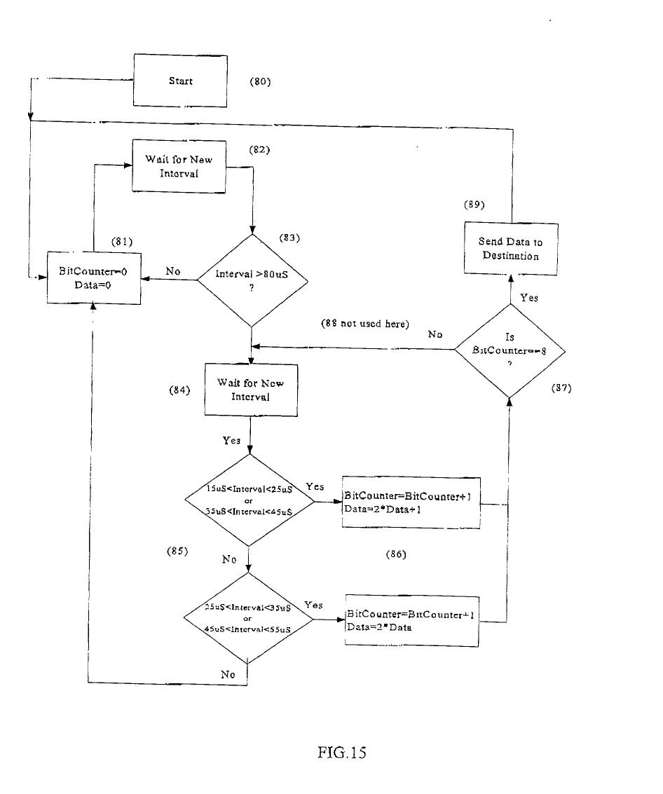

Reference is now made to FIGS. 14 and 15, which illustrate flowcharts of decoding intervals in accordance with preferred embodiments of the present invention, corresponding respectively to the embodiments of FIGS. 7A and 7B.

The decoding algorithm may start (step 80) by clearing two variables, such as Bit Counter and Data (step 81). The decoding then waits for a new interval input. If an interval is shorter than a predefined period, such as but not limited to, 80 μs (step 83) (as with normal video content) the two variables are kept cleared. If a period longer than the predetermined period is found, it is assumed to be the preamble. After waiting for a new interval (step 84), the new interval may be compared with predefined limits to define a legal interval for a “one” bit or a “zero” bit (step 85). For example, in the embodiment of FIG. 14, the legal “one” interval may be in tile range of 24-30 μs, whereas the legal “zero” interval may be in the range of 34-40 μs. As another example, in the embodiment of FIG. 15, the legal “one” interval may be in the range of either 15-25 μs or 35-45 μs, whereas the legal “zero” interval may be in the range of 25-35 μs or 45-55 μs.

If no legal interval is found, the two variables Bit Counter and Data are cleared (back to step 81) and the system waits for a new preamble (step 82). If a legal interval is found, the Bit counter variable nay be incremented and the Data variable may be updated according to the new bit (step 86). Those skilled in the art may appreciate that in the preferred embodiment the data is sent where the most significant bit is sent first. However, other bit order methods may be used. The decoding procedure may check if eight bits were decoded (step 87). If the Bit Counter has reached eight bits, the data is sent to an information destination (step 89) and the algorithm waits for a new preamble. In the embodiment of FIG. 14, the decoding method may wait for a new interval between the right segment and the left segment of the next line (step 88). In the embodiment of FIG. 15, the interval between the right segment and the left segment of the next line is also used for transmission.

Reference is now made to FIGS. 16A and 16B, which illustrate two portable devices for coupon redemption, constructed and operative in accordance with two preferred embodiments of the present invention. In FIG. 16A, the portable device may comprise a graphic LCD display. In FIG. 16B, the portable device may comprise a smart card reader or writer. The difference between the two versions lies in the method of coupon redemption. In the LCD version of FIG. 16A, the coupon may be displayed as graphical barcode and read by a POS barcode reader (not shown). The embodiment of FIG. 16B may write the coupon information into the memory of a smart card that may be read at the POS by a smart card reader (not shown).

The data modulation of the present invention may be used to download information from a screen to a portable device in applications such as, but not limited to; smart cards, credit cards, electronic coupons, programmable portable devices, controllers, toys, personal data assistants (PDAs), video verification, video watermarking, loadable greeting cards and loadable multimedia devices.

In one embodiment of the present invention, a method is provided for enhancing TV promotions. TV advertising is the leading medium for creating brand awareness and promoting new products. It is also the major revenue source of the TV industry. Yet, most viewers dislike commercials and “zap” to another station during commercial breaks. Some modem digital video recorders (DVRs) compound this problem, enabling users to skip commercials altogether while watching pre-recorded television shows.

The present invention provides a technique to improve the reach and effectiveness of TV advertising and coupons. In one method of the invention, coupons are integrated into TV advertisement campaigns, providing the coupons to viewers on-screen during TV commercials (T-coupons), using the Widely available TV infrastructure.

One method of the invention offers several advantages, amongst them:

a. Coexistence with standard TV content—The digital information may be added to the video content in short bursts, with small interference to the viewer. The receiver is capable of spotting these bursts and disregards the rest of the video content.

b. The method requires no change to hardware or software in the TV set or broadcasting equipment and uses no Set-Top box (STB).

c. The receiver is based on low cost components: photodiode, operational amplifiers, interval counter, low-end microprocessor and LCD display. This enables low-cost, high-volume production of the receiver.

In accordance with a preferred embodiment of the present invention, a method for enhancing TV promotion includes defining coupon details. For example, a marketing person may define the coupon details—ID or bar-code number, a short description and a promotion offer, for example. A software program may be used to generate a video format of the digital data.

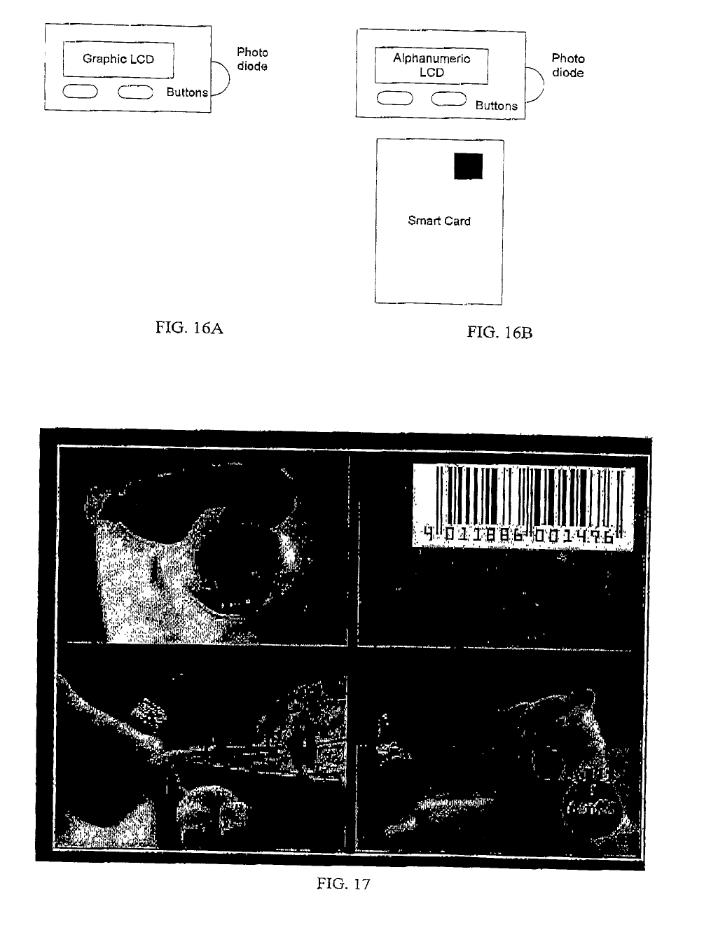

An advertising agency may insert the digital data into the advertisement video. These information bursts may be timed (by the agency that prepares the advertisement) to match the video content and flow. The agency may also insert “get ready” prompts or other effects to let the viewer know that a coupon is about to be shown. Examples of one or more simple “get ready” prompts are shown in FIG. 17.

The TV broadcaster may transmit the combined video signal in the same manner as normal TV commercials. The viewer may see the “get ready” prompt or the data bursts, such as but not limited to a bar code or trademark (e.g., COCA-COLA), point the receiving device (whose block diagrams are described hereinabove with reference to FIGS. 9 and 10) at the screen (2-3 meters away) and press a receive button. An audio signal may indicate that the bursts are spotted (“RECEIVE IN PROGRESS”) and that the download is complete (“RECEIVE OK”).

Another method of coupon loading is the use of in-shop TV promotions Information kiosks or in-shop TV monitors may present coupons in parallel with normal commercial presentations.

Having the coupons, either from home TV or shop TV, the viewer (now a potential shopper) may see the coupon details on an LCD screen of the receiving device, or download the coupon to a smart-card based retail loyalty card. The shopper may take the device or card to a store, select the product from a shelf and go to a checkout point or Point-Of-Sale (POS). The shopper may locate the coupon on the device and use the device's LCD screen to present a barcode to the POS barcode scanner.

If a smart-card based loyalty card is used (at a smart-card enabled POS), the shopper may download information to the smart card at home and present the card at the POS, transmitting the coupon automatically. The POS is thus provided with information to redeem the coupon.

The device may transfer the coupon data to a POS/data-kiosk by means of infrared transmission, RF transmission (e.g., BLUETOOTH technology), or direct electrical contacts. The device may erase the coupon when the reading process is done. Data mining techniques, used by the retailer, advertising agency or any other entity in the chain, may be used to measure the effectiveness of the TV promotion.

As mentioned hereinabove, the invention is suitable for applications, such as but not limited to: smart cards, credit cards, electronic coupons, programmable portable devices, controllers, toys, personal data assistants, video verification, video watermarking, loadable greeting cards and loadable multimedia devices.

The possibility to add digital information to TV promotion enables the advertising campaign to be interactive using non-interactive television. In general, the commercial may present different content while sending digital information in a synchronized manner.

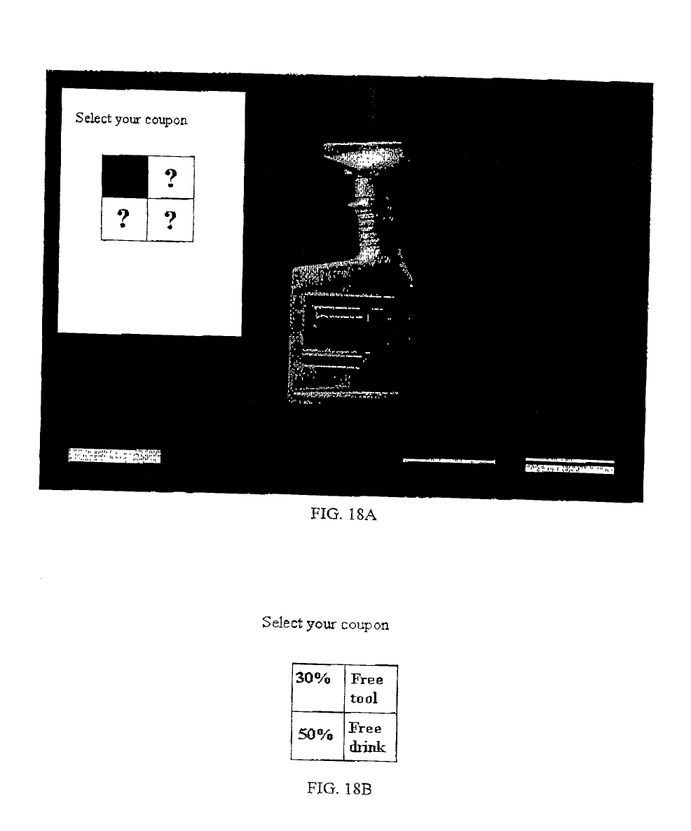

Reference is now made to FIGS. 18A and 18B, which illustrates one example of a method for interactive advertising using non-interactive television, in accordance with an embodiment of the present invention. In order to enhance viewer participation and add fun to the process, the user may load one of four unknown coupons. In the illustrated example, four hidden coupons may be shown on the screen (FIG. 18A) and the “cards” may be highlighted, one after the other, together with synchronized coupon transmission. The user may select one card and receive a “surprise” coupon. At the end of the commercial, the cards may be unveiled (FIG. 18B) and the viewer may see what coupon was given to him compared with other offers. Such interactive game may increase the interest and fun in watching TV commercials.

One example of an interactive method of the present invention comprises a toy, such as a talking doll, sold with hidden abilities. For example, the toy may have 100 sentences in its memory, but only 10 will be enabled to a user, such as a child, to use. The toy comprises any of the receivers of the invention for receiving the data transmitted on a TV screen. When the user watches a particular TV show, an information key may be transmitted from the TV screen to the toy. The key may provide more capabilities to the toy, e.g., the key may provide access to more of the sentences or other features. The user gets the impression that he/she receives gifts from die TV screen. Such an embodiment may increase the loyalty of the user to the TV show.

It will be appreciated by persons skilled in the an that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. A method for data modulation comprising:
transmitting lines of data on a screen, said lines comprising at least one of at least two different colors; and
modulating said data as a function of a period of time between consecutive transitions between two different colors.

2. The method according to claim 1 wherein said modulating comprises modulating said data as a function of a period of time between consecutive transitions between two different colors on different lines.

3. The method according to claim 1 wherein said modulating comprises modulating said data as a function of a period of time between consecutive transitions between two different colors on the same line.

4. The method according to claim 3 wherein said modulating comprises encoding one-bit per line of data.

5. The method according to claim 3 wherein said modulating comprises encoding more than one-bit per line of data.

6. The method according to claim 4 wherein said encoding comprises providing a first segment of a first color on one side of the line and providing a second segment of said first color separated from said first segment by a second color.

7. The method according to claim 5 wherein said encoding comprises modulating said data in relation to at least one of horizontal and vertical blanking of said lines of data.

8. The method according to claim 7 wherein said encoding comprises transmitting no information during vertical blanking, and transmitting a preamble on a beginning of data in a new field.

9. The method according to claim 7 wherein said encoding comprises, during horizontal blanking, representing a one bit with a first time interval between two segments of color and representing a zero bit with a second time interval between two segments of color.

10. The method according to claim 1 wherein said modulating comprises forming a preamble adapted to differentiate said data transmitted on said screen from another portion of said screen.

11. The method according to claim 10 wherein said modulating comprises forming said preamble with lines of at least two different colors.

12. The method according to claim 11 wherein said modulating comprises forming said preamble with white and black lines, wherein an average value of said preamble is at least close to halfway between black and white gray levels.

13. The method according to claim 11 wherein said modulating comprises forming said preamble with white and black lines, wherein said preamble comprises a distance of a predefined number of lines between a predefined number of transitions between black and white.

14. The method according to claim 13 wherein said modulating comprises representing a zero bit with a black-white segment.

15. The method according to claim 13 wherein said modulating comprises representing a one bit with a black-black-white segment.

16. The method according to claim 13 wherein said modulating comprises representing a one bit with a white-black-white segment.

17. The method according to claim 1 wherein said modulating comprises video-editing fill frames of said data comprising both odd and even lines of said data.

18. The method according to claim 1 wherein said modulating comprises video-editing said data comprising at least one of odd and even lines of said data.

19. The method according to claim 18 and further comprising presenting said data in fields comprising at least one of odd-lines fields and even-lines fields.

20. The method according to claim 18 and comprising separating odd-lines fields and even-lines fields of said data.

21. The method according to claim 1 and further comprising decoding said data that has been modulated.

22. The method according to claim 21 wherein said modulating comprises forming a preamble adapted to differentiate said data transmitted on said screen from another portion of said screen, and wherein said decoding comprises:
clearing two variables;
waiting for an input of an interval; and
if said interval is shorter than a predefined period, keeping said to variables cleared, and if said interval is longer than said predefined period, then said data comprises said preamble.

23. The method according to claim 22 wherein said decoding further comprises:
waiting for an input of a new interval; and
comparing said new interval with predefined limits to define a legal interval.

24. The method according to claim 23 wherein said legal interval comprises a legal “zero” interval having a first predefined duration and a legal “one” interval having a second predefined duration.

25. The method according to claim 11 wherein said modulating further comprises adding at least one of error detection bits and error correction bits to said preamble.

26. The method according to claim 11 wherein said modulating further comprises adding a toggle bit to said preamble, wherein said toggle bit is adapted to be toggled between one and zero.

27. The method according to claim 1 wherein said modulating comprises integrating a coupon into a television (TV) advertisement campaign, said coupon being viewable on-screen during a TV commercial.

28. The method according to claim 1 wherein said transmitting comprises transmitting an information key that provides access to a hidden feature of a receiver used to receive said data.

29. A method for data modulation comprising:
integrating a coupon into a television (TV) advertisement campaign, said coupon being viewable on a TV screen during a TV commercial and receivable from said screen by a viewer.

30. The method according to claim 29 and further comprising inserting in said coupon a “get ready” prompt adapted to let a viewer know that said coupon is about to be shown on said screen.

31. The method according to claim 29 and further comprising downloading said coupon to a download device.

32. The method according to claim 31 wherein said downloading comprises downloading said coupon to a smart card.

33. The method according to claim 31 and further comprising transferring data from said download device to at least one of a Point-Of-Sale (POS) device and a data kiosk.

34. The method according to claim 29 and further comprising issuing interactive commands with said coupon.

35. A method for data modulation comprising:
transmitting data on non-interactive television; and
modulating at least a portion of said data to permit a viewer to interact with data.

36. The method according to claim 35 wherein said transmitting comprises transmitting data associated with a TV commercial.

37. The method according to claim 35 wherein said transmitting comprises transmitting an information key that provides access to a hidden feature of a receiver used to receive said data.
